(19) United States
(12) Patent Application Publication
(10) Pub. No.: US 2007/0225420 A1
(43) Pub. Date: Sep. 27, 2007

(54) Granule useful for highly thermal-conductive resin composition

(75) Inventors: Shintaro Komatsu, Tsukuba-shi (JP); Mitsuo Maeda, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/723,439

(22) Filed: Mar. 20, 2007

(30) Foreign Application Priority Data
Mar. 23, 2006 (JP) 2006-080240
Sep. 29, 2006 (JP) 2006-267176
Nov. 2, 2006 (JP) 2006-298612

(51) Int. Cl. C04B 26/06

(52) U.S. Cl. 524/437; 428/402

(57) ABSTRACT

Granules useful for highly thermal-conductive resin composition are provided. The Granules have a number average particle diameter of 0.5 to 5 mm, obtained by granulating fibers mainly containing fibers selected from alumina fibers and carbon fibers, wherein the fibers to be granulated have a number average fiber diameter of 1 to 50 μm.

### BACKGROUND OF THE INVENTION

1. Field of the Invention

The present invention relates to a granule and an agent comprising the granule, both of which are useful for a highly thermal-conductive resin composition. The thermal-conductive resin composition is suitable for use in electric and electronic parts.

2. Description of the Related Art

Recently, decrease of size and increase of performance in electric and electronic parts result in considerable heat-generation in those parts. Electric and electronic parts that are provided with insufficient countermeasures for heat radiation have a problem of performance degradation thereof due to accumulation of heat. From the viewpoint of solving the problem and of safety against heat-generation, high thermal conductivity is increasingly emphasized in members used in electric and electronic parts.

Conventionally, as materials required to have highly thermal conductivity, metal materials have been mainly used. However, those metal materials have disadvantages in lightweight properties and moldability for accommodating decrease of size in electric and electronic parts, and have been substituted by resin materials.

However, resin materials generally have low thermal conductivity, and it is generally difficult to make resin materials having high thermal conductivity in themselves. Therefore, a method for imparting high thermal conductivity to resin materials by highly filling a spherical filler comprising a highly thermal-conductive material such as copper, aluminium and aluminium oxide is widely used (e.g., see, JP-A-62-100577; JP-A-04-178421; and JP-A-05-86246). Thermoplastic resins having high thermal conductivity by being filled with fibrous fillers comprising the materials exemplified above have also been reported (e.g., see, JP-A-08-283456; JP-A-09-157403, corresponding to U.S. Pat. No. 6,120894).

However, techniques disclosed in the above patents cannot provide sufficiently high thermal conductivity to resin materials, and thus the resin materials are difficult to be applied to members involved in electric and electronic parts.

### SUMMARY OF THE INVENTION

The present invention provides a granule having high thermal conductivity suitable for use in electric and electronic parts and excellent workability in producing a molded resin, and a thermal-conductive resin composition comprising the granule for producing a molded article having high thermal conductivity.

As the result of extensive investigation, the present inventors have accomplished the present invention.

That is, the present invention provides a granule having a number average particle diameter of 0.5 to 5 mm and comprising fibers, wherein the fibers have a number average fiber diameter of 1 to 50 μm and are selected from a group consisting of carbon fibers and alumina fibers mainly containing alumina.

The present invention also provides an agent comprising the above-mentioned granule.

Further, the present invention provides a resin composition comprising the above-mentioned granule and a resin selected from a thermosetting resin and a thermoplastic resin.

Moreover, the present invention provides a molded article obtainable by molding the resin composition.

The above-mentioned granule of the present invention can be a filler having excellent workability as a thermal conductivity-imparting agent that imparts high thermal conductivity to resin. A resin composition comprising the granule can serve as a highly thermal-conductive (i.e., heat conductive) resin composition. From the resin composition, members having high thermal conductivity, particularly members involved in electric and electronic parts can be easily obtained.

### DETAIL DESCRIPTION OF PREFERRED EMBODIMENTS

A granule of the present invention has a number average particle diameter of 0.5 to 5 mm. The granule comprises fibers which have a number average fiber diameter of 1 to 50 μm and are selected from a group consisting of carbon fibers and alumina fibers mainly containing alumina.

As mentioned above, the fibers as one of raw materials in the present invention are fibers which are selected from a group consisting of carbon fibers and alumina fibers mainly containing alumina. Here, “alumina fibers mainly containing alumina” means that the alumina fibers contain 50% by weight or more of alumina (i.e., aluminium oxide (Al₂O₃)). The alumina content in the alumina fibers mainly containing alumina is preferably 50% by weight or more, more preferably 70% by weight or more, and most preferably 90% by weight or more, on the basis of the alumina fibers mainly containing alumina. The alumina fibers may contain ingredients other than alumina, such as silica (SiO₂).

The number average fiber diameter of the fiber used for the granule of the present invention is 1 to 50 μm, preferably 1 to 30 μm, and more preferably 1 to 20 μm. A fiber of a larger fiber diameter may have poor moldability, and a fiber of a smaller fiber diameter may have easy frangibility in molding and a poor improving effect in thermal conductivity, which are unfavorable.

The length of the fiber is not specifically limited. Among fibrous fillers generally commercially available, a fibrous filler of 0.1 to 100 mm length is easily available and a fiber within the range may be used. The length thereof is preferably 0.1 to 80 mm, and more preferably 0.1 to 50 mm. The length of the fiber within the range described above is preferable because a resin composition described below has good moldability and more improved thermal conductivity.

Specific examples of the fibrous filler easily commercially available include: fibers mainly consisting of alumina (hereinafter, referred to as “alumina fibers”) such as ALTEX (manufactured by Sumitomo Chemical Co., Ltd.), Denka Alcen (manufactured by Denki Kagaku Kogyo K. K.), MAFTEC bulk fiber (manufactured by Mitsubishi Chemical Functional Products, Inc.) and Saffil alumina fiber (manufactured by Saffil Japan is Limited); and carbon fibers, preferably pitch based carbon fibers such as DIALEAD (manufactured by Mitsubishi Chemical Functional Products, Inc.) and GRANOC (manufactured by Nippon Graphite Fiber Corporation).

The fiber may be selected from the alumina fibers when a molded article of a resin composition described below is required to have an insulation property, or from the carbon fibers when required to have electrical conductivity. Alternatively, the molded article may have an adjusted electrical conductivity by mixing both fibers.

Further, the fiber preferably has a bulk density of 0.2 to 1.0 g/cm³ determined according to JIS K5101-12. Use of such a fiber provides advantages of easier production of the granule of the present invention and more improved thermal conductivity of a molded article of a resin composition described below. The bulk density is more preferably 0.2 to 0.5 g/cm³, and still more preferably 0.2 to 0.4 g/cm³, and most preferably 0.2 to 0.35 g/cm³. A fiber of such a bulk density may be in the form of fluff, which is granulated as described below into a granule having improved operability in preparation of the thermal-conductive resin composition of the present invention.

The granule of the present invention can be produced from the above-mentioned fibers by granulation. The method for granulation may be a known method, including stirring granulation, vibration granulation, crushing granulation and the like. In the present invention, stirring granulation is particularly preferable. Examples of a mixer used in the stirring granulation include a tumbler, a Nauta Mixer, a ribbon type blender and a Henschel mixer. From the viewpoint of short time processing,. the Henschel mixer is preferable.

The number average particle diameter of the granule is 0.5 mm to 5 mm, more preferably, 1 mm to 2 mm, and most preferably 1 mm to 1.5 mm. A granule having a number average particle diameter of not less than 0.5 mm has good workability, particularly in preparing the resin composition described below, while a granule having a number average particle diameter of not more than 5 mm has good dispersibility in fused resin in preparing a molded article by melting the resin composition, both of which are preferable because providing good moldability.

Such a number average particle diameter can be controlled by stirring conditions in granulation, such as a stirring rate and a stirring period. The stirring conditions, which may be varied according to a mixer used, may be optimized through preliminary tests.

After the granulation, particle size classification for removing the smaller and the larger particles may be carried out obtain the granule having the number average particle diameter of 0.5 to 5 mm. Examples of the particle size classification include wet particle size classifications using such as a hydrocyclon classifier, a siphon sizer, a rake classifier and a spiral classifier and dry particle size classifications using such as a cyclone classifier, an inertial classifier and a sieve.

For the granulation while stirring, any known method can be used, including a method of using the stirring granulator for granulating a powder as described above, a method of charging a fiber in an adequate solvent and stirring and drying the fiber, and a method of stirring a fiber with a mixer or the like with spraying an adequate solvent and drying the fiber, for example. A method of stirring an aggregate of fibers with a mixer or the like with spraying an adequate solvent and drying may also be possible. In those methods, a solvents such as water, organic solvents and mixtures thereof may be used. The solvent is preferably water or a mixed solvent of water with an organic solvent (which mainly consists of water), and is most preferably water.

In the granulation while stirring (herein after referred to as “stirring granulation”) in the present invention, the solvent may further comprise a sizing agent.

Any sizing agent can be used without specific limitation. Specific examples of the sizing agent include silane and/or titanate coupling agents.

Examples of the silane coupling agent include γ-mercaptopropyltrimethoxysilane, 2-styrylethyltrimethoxysilane, N-β-(aminoethyl)-γ-aminopropyltrimethoxysilane, β-(3,4-epoxycyclohexyl)ethyltrimethoxysilane, γ-glycidoxypropyltrimethoxysilane, phenyltrimethoxysilane, methyldimethoxysilane, which may be used alone or in combination of two or more kinds.

Examples of the titanate coupling agent include isopropyl tri-isostearoyl titanate, isopropyl trioctanoyl titanate, isopropyl tri(dioctyl pyrophosphate)titanate, isopropyl tridimethacryl isostearoyl titanate, isopropyl tri(N,N-diaminoethyl)titanate, isopropyl tridodecylbenzenesulfonyl titanate, isopropyl isostearoyl diacryl titanate, isopropyl tri(dioctyl phosphate)titanate, isopropyl tricumylphenyl titanate, tetraisopropyl bis (dioctyl phosphate)titanate, tetraoctyl bis(didodecyl phosphate)titanate, tetra(2,2-diallyloxymethyl-1-butyl)bis(ditridecyl)phosphate titanate, bis(dioctyl pyrophosphate)oxyacetate titanate and bis (dioctyl pyrophosphate) ethylene titanate, which may be used alone or in combination of two or more kinds. The silane coupling agent and the titanate coupling agent may be used together.

When the coupling agent is used, the amount of the coupling agent may be not more than 5 parts by weight, and is preferably not more than 2 parts by weight to 100 parts by weight is on the basis of the total amount of fibers. The granule of the present invention is improved little in thermal conductivity with the sizing agent such as the coupling agent. Too large an amount of the coupling agent tends to reduce thermal conductivity and mechanical properties of the resulting resin composition, that is unfavorable, but a small amount of the coupling agent may be used, because the granule obtained from a fibrous filler treated with the small amount of the coupling agent has increased compatibility with a resin to be mixed and the resin has an improved feeding property in molding a thermal-conductive resin composition as described below.

The granule of the present invention may also be prepared directly by using a granulator without the solvent and the sizing agent, in order to increase of productivity. Such a preparing method is preferable from the viewpoint of less tendency of fibers constructing the granule to be broken after granulation, as well as an advantage of the method of eliminating a drying step and the like.

The granule of the present invention can be obtained as described above, which may be obtained after being subjected to the particle size classification described above to adjust the number average particle diameter of the granule within the range of the present invention.

The granule of the present invention may provide an agent which can serves as a thermal conductivity-imparting agent that considerably improves thermal conductivity of a resin, as it is or by mixing with an optional additive and the like. The present inventors have thought that thermal conductivity of conventional thermal-conductive resin compositions containing agents (fillers) with highly thermal conductivity is not sufficiently high due to a small chance of contact between the agents. Based on such thought, the present inventors have studied fillers in terms of its shape and dispersibility so as to increase the chance of contact between the fillers. As a result, the present inventors have found that the granule provided by the present invention can impart high thermal conductivity to a resin and can have excellent workability when the granule is mixed with the resin and molded.

In the present invention, the granule may be blended with a resin such as a thermosetting resin and a thermoplastic resin, to provide a resin composition.

When blending the granule with a thermosetting resin, a thermoplastic resin, or a mixed resin thereof, the amount of the granule blended can be selected in a wide range according to the desired thermal conductivity. Particularly, when the resin is a thermosetting resin, the granule is blended preferably in an amount of 10 to 300 parts by volume, more preferably 20 to 200 parts by volume, and most preferably 40 to 200 parts by volume, on the basis of 100 parts by volume of uncured thermosetting resin to be blended. When the ratio of the granule added to the thermosetting resin is within the range described above, the thermosetting resin composition obtained therefrom excellently improves thermal conductivity of a molded article obtained therefrom. For example, a highly thermal-conductive resin composition and a highly thermal-conductive molded article, both of which may have a thermal conductivity of about 1.5 W/mK (measured at 20° C.) or higher, can be obtained in the present invention.

When the resin is a thermoplastic resin, the granule is blended preferably in an amount of 10 to 100 parts by volume, more preferably 25 to 90 parts by volume, and most preferably 40 to 85 parts by volume, on the basis of 100 parts by volume of the thermoplastic resin. When the ratio of the granule added to the thermoplastic resin is within the range described above, the thermoplastic resin composition obtained therefrom excellently improves thermal conductivity of a molded article of the thermoplastic resin composition, and is easily molded due to its good flowability when fused and molded. Further, a member obtained from the resin composition by molding has excellent mechanical strength.

The resin composition, which can be obtained by blending the granule with a thermosetting resin, a thermoplastic resin, or a mixed resin thereof, may be molded to provide a molded article having improved thermal conductivity.

Examples of the thermosetting resin include phenol resins, unsaturatedpolyesters, epoxy resins, vinyl ester resins, alkyd resins, acrylic resins, melamine resins, xylene resins, guanamine resins, diallyl phthalate resins, allyl ester resins, furan resins, imide resins, urethane resins, urea resins and diene resins, which may be used alone or in combination of two or more kinds.

Among them, preferred are phenol resins, unsaturated polyesters, epoxy resins, vinyl ester resins, allyl ester resins, diene resins, and particularly preferred are epoxy resins from the viewpoint of good heat resistance after being cured. Conception of said epoxy resins includes resins obtained typically by glycidyl-etherifying a phenolic hydroxyl group of a polyhydric phenol such as bisphenol A, bisphenol S, bisphenol F and triphenoxymethane with epihalohydrin and the like and oligomerizing the resultant compound and epoxy resins obtained by glycidyl-etherifying a polymer having a plurality of phenolic hydroxyl groups such as novolac resins and polyhydroxystyrene with epihalohydrin and the like. Epoxy resins that are easily commercially available (e.g., available from Japan Epoxy Resin Co., Ltd.) may also be used.

Into the resin composition having the thermosetting resin, may further be added a curing agent and/or a curing accelerator, which may be widely used to easily cause curing reaction. Examples of the curing agent and/or curing accelerator include radical-generating catalysts such as peroxides and azo compounds for thermosetting resins having a carbon-carbon unsaturated bond as a reactive group for curing such as unsaturated polyester, vinyl ester resins, allyl ester resins and diene resins and amine compounds such as hexamethylenetetramine for novolac resins. In the case of epoxy resins, a curing agent such as an acid, amine and acid anhydride may be used together with a compound such as a phosphorous compound, a quaternary ammonium salt, imidazole, a trifluoroborane complex and a transition metal acetylacetonate as a curing accelerator.

The above-mentioned thermoplastic resin to be used in the resin composition of the present invention has no specific limitation, and is preferably a resin moldable at a molding temperature of 200 to 450° C. Examples of the thermoplastic resin includs polyolef in, polystyrene, polyamide, halogenated vinylresins, polyacetal, saturatedpolyester, polycarbonate, polyallylsulfone, polyallylketone, polyphenylene ether, poly(phenylene sulfide) or polyphenylene sulfide sulfone, polyarylate, liquid crystal polyester and fluorine resins. At least one thermoplastic resin selected from the group described above may be used alone, or a polymer alloy consisting of two or more of the thermoplastic resins selected from the group may be used.

Among the thermoplastic resins, preferred are liquid crystal polyester, polyether sulfone, polyarylate, poly(phenylene sulfide), polyamide 4/6 and polyamide 6T, which are excellent in heat resistance, more preferred are polyphenylene sulfide and liquid crystal polyester, which are particularly excellent in heat resistance, and further more preferred is liquid crystal polyester, from the viewpoint of excellent thin-wall moldability. The thermoplastic resin excellent in thin-wall moldability is preferably used to form a member used in electric and electronic parts.

Polyphenylene sulfide may be a resin comprising mainly a repeating structural unit represented by the following formula (10):

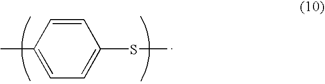

The polyphenylene sulfide can be produced, for example, by a reaction of a halogen-substituted aromatic compound with alkali sulfide (as disclosed in U.S. Pat. No. 2,513,188 and JP-B-S44-27671), a condensation reaction of thiophenol in the presence of an alkali catalyst or copper salt and the like (as disclosed in U.S. Pat. No. 3,274,165 and the like), or a condensation reaction of an aromatic compound with sulfur chloride in the presence of a Lewis acid catalyst (as disclosed in JP-B-S46-27255). Polyphenylene sulfide easily commercially available (e.g., available from Dainippon Ink and Chemicals Incorporated, for example) may also be used.

As mentioned above, a liquid crystal polyester is also preferably used as the thermoplastic resin.

The liquid crystal polyester may be referred to as a thermotropic liquid crystal polymer, and forms a melted body exhibiting optical anisotropy at temperatures not more than 450° C. Specific examples of the liquid crystal polyester include:

(1) those obtained by polymerization among aromatic hydroxycarboxylic acids, aromatic dicarboxylic acids and aromatic diols;

(2) those obtained by polymerization of different types of aromatic hydroxycarboxylic acids;

(3) those obtained by polymerization of aromatic dicarboxylic acids with aromatic diols; and

(4) those obtained by reaction of crystalline polyester such as poly(ethylene terephthalate) with aromatic hydroxycarboxylic acids.

Ester-forming derivatives of those aromatic hydroxycarboxylic acids, aromatic dicarboxylic acids and aromatic diols are preferably used instead of those acids and diols, because the liquid crystal polyester is more easily prepared therefrom.

In the case of aromatic hydroxycarboxylic acids and aromatic dicarboxylic acids intramolecularly having a carboxyl group, examples of the ester-forming derivative include those obtained by conversion of the carboxylic acid group to a highly reactive group such as an acid halogen group and an acid anhydride, and esters with alcohols and ethylene glycol that will form polyesters by transesterification. In the case of aromatic hydroxycarboxylic acids and aromatic diols intramolecularly having a phenolic hydroxyl group, examples of the ester-forming derivative include esters of the phenolic hydroxyl group with lower carboxylic acids that will form polyesters by transesterification.

Further, those aromatic hydroxycarboxylic acids, aromatic dicarboxylic acids and aromatic diols may have substituents such as a halogen atom, an alkyl group and an aryl group on an aromatic ring of those acids and diols to the extent that the ester-forming properties thereof are not disturbed.

Examples of the repeating structural unit in the liquid crystal polyester of the present invention include, but are not limited to:

repeating structural units derived from aromatic hydroxycarboxylic acids:

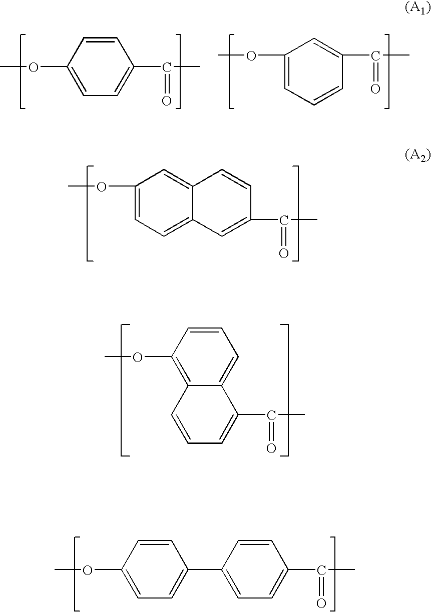

wherein aromatic rings of those repeating structural units may be substituted with a halogen atom, an alkyl group or an aryl group;

repeating structural units derived from aromatic dicarboxylic acids:

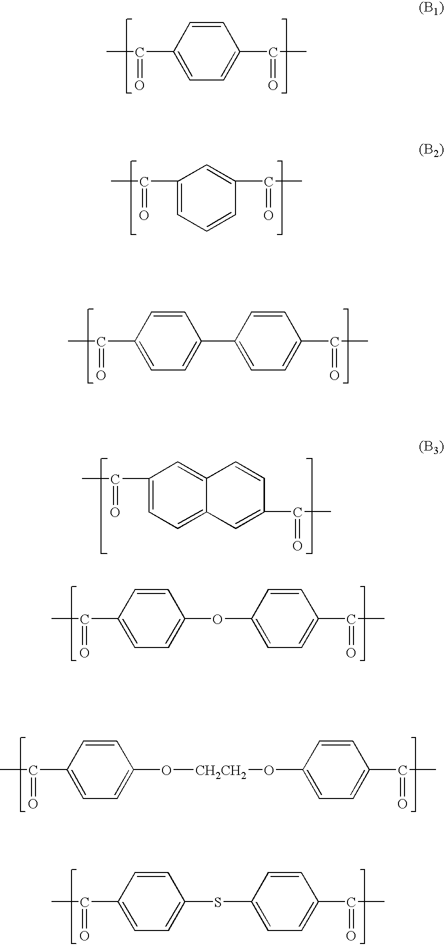

wherein aromatic rings of those repeating structural units may be substituted with a halogen atom, an alkyl group or an aryl group; and

repeating structural units derived from aromatic diols:

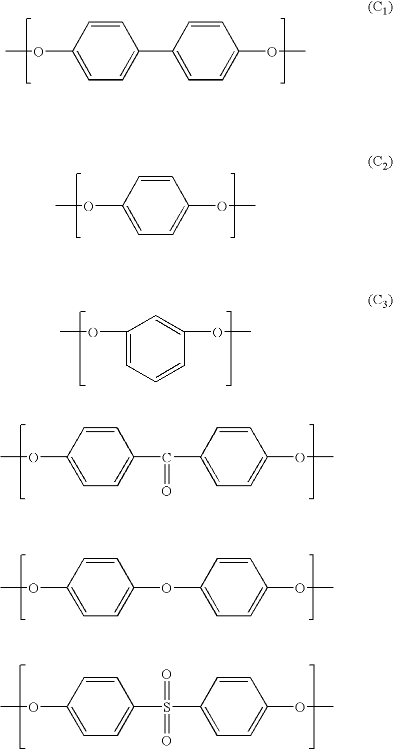

wherein aromatic rings of those repeating structural units may be substituted with a halogen atom, an alkyl group or an aryl group.

The alkyl group is preferably an alkyl group having 1 to 10 carbon atoms, and more preferably a methyl group, an ethyl group or a butyl group. The aryl group is preferably an aryl group having 6 to 20 carbon atoms, and more preferably a phenyl group. Examples of the halogen atom include a fluorine atom, a chlorine atom and a bromine atom.

From the viewpoints of the balance of heat resistance, mechanical properties and processability, particularly preferred liquid crystal polyester comprises the repeating structural unit represented by the formula (A₁) in an amount of at least 30% by mol of the total repeating structural units that construct the liquid crystal polyester.

Specific examples of the combination of repeating structural units include the following (a) to (f):

(a): a combination of (A₁), (B₁) and (C₁), or (A₁), (B₁), (B₂) and (C₁);

(b): a combination of (A₂), (B₃) and (C₂), or (A₂), (B₁), (B₃) and (C₂);

(c): a combination of (A₁) and (A₂);

(d): a combination obtained from the combination of structural units (a) by replacing a part or whole of (A₁) with (A₂);

(e): a combination obtained from the combination of structural units (a) by replacing a part or whole of (B₁) with (B₃);

(f): a combination obtained from the combination of structural units (a) by replacing a part or whole of (C₁) with (C₃);

(g): a combination obtained from the combination of structural units (b) by replacing a part or whole of (A₂) with (A₁); and

(h): a combination obtained by adding structural units (B₁) and (C₂) to the combination of structural units (c).

Liquid crystal polyesters of (a) and (b), which are of primal structures, are respectively exemplified in JP-B-S47-47870 and JP-B-S63-3888 (which are incorporated herein).

As for a method for preparing the liquid crystal polyester, a known method, for example, described in JP-A-2002-146003 is applicable. The exemplified method comprises: subjecting the monomer (aromatic hydroxycarboxylic acids, aromatic dicarboxylic acids, aromatic diols or ester-forming derivatives thereof) to melt polycondensation to give a relatively lower molecular weight aromatic liquid crystal polyester (hereinafter, abbreviated as a “prepolymer”), making the prepolymer into a powder, and heating the powder to cause solid phase polymerization. By the solid phase polymerization, polymerization can be further progressed, resulting in polymers of higher molecular weight.

From the viewpoint of development of liquid crystallinity, the liquid crystal polyester used in the present invention preferably comprises:

30 to 80% by mol of repeating structural units derived from p-hydroxybenzoic acid and/or 2-hydroxy-6-naphthoic acid;

10 to 35% by mol of repeating structural units derived from at least one compound selected from the group consisting of hydroquinone and 4,4′-dihydroxybiphenyl; and

10 to 35% by mol of repeating structural units derived from at least one compound selected from the group consisting of terephthalic and isophthalic acids, on the basis of 100% by mol of the total amounts of the repeating structural units that constructing the liquid crystal polyester.

In the present invention, one or more of commonly used additives may be added within the range of not impairing the object of the present invention. Examples of the additives include fillers such as glass fiber, mold release improvers such as fluorine resin and metallic soaps, colorants such as dyes and pigments, antioxidants, heat stabilizers, UV absorbers, antistatic agents, surfactants, and the like. One or more of additives having an external lubricating effect such as higher fatty acids, higher fatty acid esters, higher fatty acid metal salts and fluorocarbon surfactants may also be added.

A method for preparing a composition comprising the granule of the present invention and a thermoplastic resin is not specifically limited. The method preferably comprises: mixing a thermoplastic resin and the granule of the present invention using a Henschel mixer, tumbler, or the like, and then melt kneading using an extruder is preferable. The molded article of the present invention includes a pellet, but is particularly preferably an injection-molded article of a thermoplastic resin composition. The molded article of a thermoplastic resin composition of the present invention is useful as a member for electronic parts, particularly a member required to have thermal conductivity.

The composition can be molded to provide a molded article thereof. The method of molding is not limited. The molded article can be used in various fields.

Examples of use of the molded article is as follows:

Electric parts such as cases of electric and electronic equipments, power generator, electric motor, electric transmission, current transmission, voltage regulator, commutator, voltage inverter, power junction, switch, electric current breaker, cabinet, socket, relay case;

electronic parts such as sensor, LED lamp, lamp socket, lamp reflector, lamp housing, connector, coil bobbin, capacitor, oscillator, various terminals, transformer, plug, printed-circuit board, magnetic head base, power module, parts of hard disc drive, DVD parts such as optical pickup, parts related personal computer;

heat radiation materials and insulated materials of electric components such as semiconductor device, sealing resin of coil;

parts of optical instrument such as camera; and

heat-generated parts such as bearing, parts of automobile, motorbike, train, airplane, ship and bicycle.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2006-80240 filed on Mar. 23, 2006, the Japanese Patent Application No. 2006-267176 filed on Sep. 29, 2006 and the Japanese Patent Application No. 2006-298612 filed on Nov. 2, 2006, all of them including specification, claims and summary, are incorporated herein by reference in their entirety.

### EXAMPLES

The present invention is described in more detail by following Examples, which should not be construed as a limitation upon the scope of the present invention.

### Preparation Example 1

### Preparation of Granule 1

A mixture of 100 parts by weight of alumina fiber (Denka Alcen, manufactured by Denki Kagaku Kogyo K.K., alumina content: 97% by weight, number average fiber diameter: 3.2 μm, bulk density: 0.27 g/cm³) and 30 parts by weight of water was stirred and granulated in a Henschel mixer (Supermixer G100, manufactured by KAWATAMFG Co., Ltd.) to give Granule 1. Granule 1 had a number average particle diameter of 1.3 mm as determined by a scanning electron microscopy.

### Preparation Example 2

### Preparation of Granule 2

Granule 2 was obtained by a similar procedure as in Preparation Example 1, except that 1% by weight aqueous solution of Y-glycidoxypropyltrimethoxysilane was used instead of water used in the stirring granulation in Preparation Example 1. Granule 2 had a number average particle diameter of 1.5 mm as determined by a scanning electron microscopy.

### Preparation Example 3

### Preparation of Granule 2

An alumina fiber (Denka Alcen, manufactured by Denki Kagaku Kogyo K.K., alumina content: 100% by weight, number average fiber diameter: 3.2 μm, bulk density: 0.28 g/cm³) was stirred and granulated in a Henschel mixer (Supermixer G100, manufactured by KAWATAMFG Co., Ltd.) to give Granule 3. Granule 3 had a number average particle diameter of 1.0 mm as determined by a scanning electron microscopy.

### Preparation Example 4

### Preparation of Liquid Crystal Polyester

A reactor equipped with a stirring apparatus, a torque meter, a nitrogen gas inlet pipe, a thermometer and a reflux condenser was charged with 994.5 g (7.2 mol) of p-hydroxybenzoic acid, 446.9 g (2.4 mol) of 4,4′-dihydroxybiphenyl, 299.0 g (1.8 mol) of terephthalic acid, 99.7 g (0.6 mol) of isophthalic acid and 1347.6 g (13.2 mol) of acetic anhydride. The inside of the reactor was fully substituted with nitrogen gas. The reaction mixture was heated to 150° C. over 30 minutes under nitrogen gas stream, and refluxed for 1 hour at the temperature.

Then, with removing acetic acid as a by-product and unreacted acetic anhydride, the reaction mixture was heated to 320° C. over 2 hours and 50 minutes. The reaction was considered to reach the reaction end when torque of the reaction mixture increased, and thus a prepolymer was obtained.

The resultant prepolymer was cooled to room temperature, crushed with a roughly crushing machine, and then, under nitrogen atmosphere, heated from room temperature to 250° C. over 1 hour, heated from 250° C. to 285° C. over 5 hours, and kept at 285° C. for 3 hours to progress solid phase polymerization. The resultant liquid crystal polyester had a flow-beginning temperature of 327° C. The liquid crystal polyester thus obtained is referred to as LCP1.

### Examples 1 to 5

Granules 1 and 2 (obtained in Preparation Examples 1 and 2), the liquid crystal polyester (obtained in Preparation Example 4), an unstirred alumina fiber and the following alumina particle, each amount of which are shown in Table 1 were mixed to prepare Resin compositions of Examples 1 to 5, which were then kneaded at 340° C. with a parallel twin screw extruder (PCM-30, Ikegai Tekko K.K.) to give pellets. Each of the resultant pellets was injection-molded with an injection molding machine (model PS40E5ASE, Nissei Plastic Industrial Co., Ltd.) under the conditions of a cylinder temperature of 350° C. and a mold temperature of 130° C. to give a molded rectangular block of 126 mm×12 mm×6 mm, respectively. In each Example, the obtained molded block was cut into a plate of 1 mm thickness (MD) vertical to the longest axis of the molded block, and a plate of 1 mm thickness (TD) parallel to the longest axis of the molded block, which were used as a sample for thermal conductivity evaluation. Using the samples, heat diffusion rate were measured with a laser flash thermal constant analyzer (TC-7000, manufactured by ULVAC-RIKO, Inc.). In the measurement, specific heat were obtained with a DSC (DSC7, manufactured by PERKINELMER), and specific gravity were obtained with an automatic specific gravity measuring instrument (ASG-320K, Kanto Measure K.K.). Thermal conductivity of the samples was determined by multiplying heat diffusion rate by specific heat and specific gravity.

Also, ASTM4-type tensile dumbbells were obtained from the resin compositions to measure tensile strengths of the resin compositions in the same manner as in ASTM D638.

These measurement values are shown in Table 1.

### Comparative Example 1

The same alumina fiber as used in Preparation Example 1 was directly used without granulation, i.e., ungranulated alumina fiber was used instead of Granule 1 or 2 used in Examples 1 to 5. The ungranulated alumina fiber and the liquid crystal polyester were subjected to pelletization similarly as in Examples 1 to 5, but were not mixed uniformly in a mixer and failed to be palletized.

### Comparative Examples 2 to 4

Similar experiments as Examples 1 to 5 were conducted, except that an alumina particle described below was used instead of Granules 1 and 2 used in Examples 1 to 5. The measurement values are shown in Table 2.

The alumina particles used above is Advanced alumina AA-2, manufactured by Sumitomo Chemical Co., Ltd., having a number average particle diameter of 2 μm and an alumina content of 99.6% by weight.

TABLE 1

| | Example 1 | Example 2 | Example 3 | Example 4 | Example 5 |
|---|---|---|---|---|---|
| LCP 1 (part by volume) | 100 | 100 | 100 | 100 | 100 |
| Granule 1 (part by volume) | 42.9 | 66.7 | 0 | 0 | 0 |
| Granule 2 (part by volume) | 0 | 0 | 42.9 | 66.7 | 100 |
| Granule 3 (part by volume) | 0 | 0 | 0 | 0 | 0 |
| Ungranulated alumina | 0 | 0 | 0 | 0 | 0 |
| fiber (part by volume) | | | | | |
| Alumina particle (part by | 0 | 0 | 0 | 0 | 0 |
| volume) | | | | | |
| Thermal conductivity (MD) | 3.0 | 3.7 | 3.0 | 3.5 | 2.7 |
| (W/mK) | | | | | |
| Thermal conductivity (TD) | 0.7 | 1.2 | 0.6 | 1.1 | 2.9 |
| (W/mK) | | | | | |
| Tensile strength (MPa) | 118 | 97 | 91 | 80 | 64 |

TABLE 2

| | Compar- | Compar- | Compar- | |
|---|---|---|---|---|
| | ative | ative | ative | Comparative |
| | Example 1 | Example 2 | Example 3 | Example 4 |
| LCP 1 (part by | 100 | 100 | 100 | 100 |
| volume) | | | | |
| Granule 1 (part by | 0 | 0 | 0 | 0 |
| volume) | | | | |
| Granule 2 (part by | 0 | 0 | 0 | 0 |
| volume) | | | | |
| Granule 3 (part by | 0 | 0 | 0 | 0 |
| volume) | | | | |
| Ungranulated alumina | 42.9 | 0 | 0 | 0 |
| fiber (part by volume) | | | | |
| Alumina particle (part | 0 | 42.9 | 66.7 | 100 |
| by volume) | | | | |
| Thermal conductivity | Impossible | 1.6 | 1.8 | 2.1 |
| (MD) (W/mK) | to mold | | | |
| Thermal conductivity | | 0.7 | 0.9 | 1.4 |
| (TD) (W/mK) | | | | |
| Tensile strength (MPa) | | 97 | 75 | 63 |

### Examples 6 to 8

Molded articles (pellets) in Examples 6 to 8 are obtained in the same manner as in Examples 3 to 5, except that Granule 3 (obtained in Preparation Example 3) is used instead of Granule 2.

These measurement values are shown in Table 3.

TABLE 3

| | Example 6 | Example 7 | Example 8 |
|---|---|---|---|
| LCP 1 (part by volume) | 100 | 100 | 100 |
| Granule 1 (part by volume) | 0 | 0 | 0 |
| Granule 2 (part by volume) | 0 | 0 | 0 |
| Granule 3 (part by volume) | 53.8 | 66.7 | 81.8 |
| Ungranulated alumina | 0 | 0 | 0 |
| fiber (part by volume) | | | |
| Alumina particle (part by | 0 | 0 | 0 |
| volume) | | | |
| Thermal conductivity (MD) | 4.2 | 4.5 | 5.0 |
| (W/mK) | | | |
| Thermal conductivity (TD) | 1.1 | 1.5 | 2.2 |
| (W/mK) | | | |
| Tensile strength (MPa) | 93 | 82 | 80 |

### Example 9

Polyphenylene sulfide (T-3G, manufactured by Dainippon Ink and Chemicals Incorporated) and Granule 3 (obtained in Preparation Example 3), each amount of which are shown in Table 4, were mixed to prepare Resin composition of Example 9, which were then kneaded at 300° C. with a parallel twin-screw extruder (PCM-30, Ikegai Tekko K.K.) to give a pellet. The resultant pellet was injection-molded with an injection molding machine (model PS40E5ASE, Nissei Plastic Industrial Co., Ltd.) under the conditions of a cylinder temperature of 350° C. and a mold temperature of 130° C. to give a molded rectangular block of 126 mm×12 mm×6 mm. The obtained molded block was cut into a plate of lmm thickness (MD) vertical to the longest axis of the molded block, and a plate of 1 mm thickness (TD) parallel to the longest axis of the molded block, which were used as samples for measurements. Using the samples and the resin composition, heat diffusion rate, thermal conductivity and tensile strength were measured in the same manners as in Examples 1 to 5. The measurement values of thermal conductivity and tensile strength are shown in Table 4.

TABLE 4

| | Example 9 |
|---|---|
| PPS1 (part by volume) | 100 |
| | 0 |
| Granule 3 (part by volume) | 82 |
| | 0 |
| Thermal conductivity (MD) | 3.6 |
| (W/mK) | |
| Thermal conductivity (TD) | 2.1 |
| (W/mK) | |
| Tensile strength (MPa) | 85 |

### <Preparation of Thermosetting Resin Composition and Molded Article Thereof>

### Example 10

Liquid epoxy resin was prepared from bisphenol-A epoxy resin (828, manufactured by Japan Epoxy Resin Co., Ltd.) by adding 90 parts by weight of acid anhydride (Rikacid MT-500TZ, manufactured by New Japan Chemical Co., Ltd.) as a curing agent and 0.9 parts by weight of 2-ethyl-4-methylimidazole (2E4MZ, manufactured by Shikoku Chemicals Corporation) as a curing accelerator per 100 parts by weight of bisphenol-A epoxy resin. The liquid epoxy resin was mixed with Granule 3 obtained in Preparation Example 3 in a composition shown in Table 5 to give a liquid epoxy resin composition. The resin composition was injected into a mold, allowed to cure for 2 hours at 100° C. and for 5 hours at 130° C. in a hot air drier to produce a molded resin. The resultant molded resin was cut into a plate of 1 mm thickness, which was used as a sample for thermal conductivity evaluation. In the case of the epoxy resin, since a molded article was obtained by injection into a mold, there is no distinction of MD and TD as an injection-molded article has and no directional property of thermal conductivity in the molded article. Using the sample and the resin composition, heat diffusion rate and thermal conductivity were measured in the same manners as in Examples 1 to 5, provided that in the case of the epoxy resin, thermal conductivity was determined in only one direction, since it has isotropic thermal conductivity. The measurement value of thermal conductivity is shown in Table 5.

### Comparative Example 5

The same procedures and measurements were conducted as in Example 10 except that no Granule 3 was used. The measurement value of thermal conductivity is shown in Table 5.

TABLE 5

| | | Comparative |
|---|---|---|
| | Example 10 | Example 5 |
| Epoxy resin (part by | 100 | 100 |
| volume) | | |
| Granule 3 (part by volume) | 55 | 0 |
| Thermal conductivity | 2.4 | 0.8 |
| (W/mK) | | |

What is claimed is:

1. A granule having a number average particle diameter of 0.5 to 5 mm and comprising fibers, wherein the fibers have a number average fiber diameter of 1 to 50 μm and are selected from a group consisting of carbon fibers and alumina fibers mainly containing alumina.

2. The granule according to claim 1, wherein the fibers to be granulated have a bulk density of 0.2 to 1 g/cm³.

3. The granule according to claim 1 or 2, wherein the granule is a granule obtained by granulating the fibers while stirring.

4. An agent comprising the granule according to claim 1 or 2.

5. A resin composition comprising the granule according to claim 1 and a resin selected from a thermosetting resin and a thermoplastic resin.

6. The resin composition according to claim 5, which comprises 10 to 300 parts by volume of the granule on the basis of 100 parts by volume of the thermosetting resin.

7. The resin composition according to claim 5, which comprises 10 to 100 parts by volume of the granule on the basis of 100 parts by volume of the thermoplastic resin.

8. The resin composition according to claim 5, wherein the resin is a thermoplastic resin.

9. The resin composition according to claim 8, wherein the thermoplastic resin is polyphenylene sulfide.

10. The resin composition according to claim 8, wherein the thermoplastic resin is a liquid crystal polyester.

11. The resin composition according to claim 10, wherein the liquid crystal polyester has a flow-beginning temperature of not less than 280° C.

12. The resin composition according to claim 10, wherein the liquid crystal polyester comprises:
30 to 80% by mol of repeating structural unit derived from p-hydroxybenzoic acid and/or 2-hydroxy-6-naphthoic acid;
10 to 35% by mol of repeating structural unit derived from hydroquinone and/or 4,4′-dihydroxybiphenyl; and
10 to 35% by mol of repeating structural unit derived from at least one compound selected from the group consisting of terephthalic acid, isophthalic acid and 2,6-naphthalenedicarboxylic acid;
on the basis of 100% by mol of the total amounts of the repeating structural units that constructing the liquid crystal polyester.

13. A molded article obtainable by molding the resin composition according to any of claims 5, 9 and 10.
